(19) United States
(12) Patent Application Publication
(10) Pub. No.: US 2026/0361889 A1
(43) Pub. Date: Nov. 12, 2026

(54) REAL-TIME DETECTION AND MITIGATION OF UNAUTHORIZED ACTIVITY USING STREAMING DEEP WALK, FEATURE FUSION AND DISTRIBUTED LEARNING

(71) Applicant: Bank of America Corporation, Charlotte, NC (US)

(72) Inventors: Naga Vamsi Krishna Akkapeddi, Charlotte, NC (US); Pushkar Taneja, Hyderabad (IN); Suryanarayana Adivi, Hyderabad (IN); Pratap Dande, St. Johns, FL (US)

(21) Appl. No.: 19/745,540

(22) Filed: Jul. 17, 2026

Related U.S. Application Data
(63) Continuation of application No. 18/858,499, filed on Apr. 27, 2023, now Pat. No. 12,713,031.
(60) Provisional application No. 63/336,397, filed on Apr. 29, 2022.

(51) Int. Cl. H04N 19/14; H04N 19/105; H04N 19/119; H04N 19/176

(52) U.S. Cl. CPC H04N 19/14; H04N 19/105; H04N 19/119; H04N 19/176

(57) ABSTRACT

A computing platform for detecting unauthorized activity may generate a temporal transaction graph that includes account identifiers represented as nodes and transactions between accounts represented as edges. Each edge may have an associated timestamp. Upon receiving a transaction, the computing platform may execute a localized random walk from nodes corresponding to accounts involved in the transaction to generate an updated node embedding for each involved node, without recomputing embeddings for nodes not affected by the new transaction. The platform may fuse the updated node embeddings with behavioral feature data to generate fused feature vectors. The platform may apply a temporal graph transformer model to the fused feature vectors to generate a suspicion score for each involved node and may aggregate the suspicion scores to generate a cluster score. Responsive to the cluster score meeting or exceeding a threshold, an alert signal may be generated and transmitted to a computing device.

### BACKGROUND

Aspects of the disclosure relate to electrical computers, systems, and devices for detection of unauthorized activity.

Financial institutions and other organizations that process transactions face ongoing challenges in detecting and preventing unauthorized activity. In some cases, unauthorized activity may manifest as coordinated behavior across multiple accounts rather than as isolated anomalous events. For example, groups of accounts may engage in rapid transfers of funds among themselves to obscure the origin or destination of money, with such activity forming and dissolving within short time periods. Existing approaches to detecting unauthorized activity in networks may rely on batch processing or periodic analysis of transaction data, which may introduce delays between when unauthorized activity occurs and when it is detected. Some detection systems may analyze individual transactions in isolation, which may cause difficulty detecting coordinated activity that spans multiple accounts and transactions, as each transaction in the sequence may appear unremarkable on its own.

Graph-based approaches to transaction analysis may represent accounts as nodes and transactions as edges within a graph data structure, enabling analysis of relationships and connectivity patterns among accounts. However, maintaining and analyzing graph structures for large transaction networks may present computational challenges, particularly when attempting to process transaction data in real time. Full recomputation of graph representations each time new transaction data arrives may be computationally expensive and may introduce latency that reduces the effectiveness of detection systems. Additionally, detection systems may face challenges in distinguishing between legitimate high-volume transaction activity and coordinated unauthorized activity, as accounts that process large numbers of transactions may exhibit dense connectivity patterns that could be mistakenly flagged as suspicious. Therefore, improved systems and methods for detecting unauthorized activity in transaction processing systems may be desirable.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with real-time detection of unauthorized activity using graph-based analysis.

In some examples, a computing platform may construct or generate a temporal transaction graph that includes account identifiers represented as nodes in the graph, and transactions between accounts represented as edges connecting the nodes. In some examples, each edge may have an associated timestamp. Upon receiving a new transaction, the computing platform may execute a localized random walk from one or more nodes corresponding to accounts involved in the new transaction to generate an updated node embedding for each involved node. In some examples, this may be performed without recomputing embeddings for nodes not affected by the new transaction.

In some arrangements, the computing platform may fuse the updated node embeddings with behavioral feature data associated with the involved accounts to generate fussed feature vectors. The computing platform may apply a temporal graph transformer model to the fused feature vectors to generate a suspicion score for each involved node and may aggregate the suspicion scores to generate a cluster score. The cluster score may be compared to an adaptive threshold and, if the cluster score meets or exceeds the adaptive threshold, an alert signal may be generated and transmitted to one or more computing devices.

These and various other arrangements will be discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for unauthorized activity detection in accordance with one or more aspects described herein;

FIGS. 2A-2G depict an illustrative event sequence for unauthorized activity detection in accordance with one or more aspects described herein;

FIG. 3 illustrates an illustrative method for unauthorized activity detection according to one or more aspects described herein;

FIG. 4 illustrates one example notification that may be generated according to one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The present disclosure relates to systems and methods for real-time detection and mitigation of coordinated unauthorized activity in transaction processing systems. In some cases, unauthorized activity in networks may manifest as coordinated behavior across multiple accounts rather than as isolated anomalous events. Such coordinated activity may form densely connected transaction patterns that emerge, evolve, and dissolve within short time periods, presenting technical challenges for detection systems that rely on batch processing or periodic analysis of data.

Aspects described herein address these technical challenges through a combination of temporal graph construction, streaming embedding updates, and machine learning-based scoring. In some arrangements, a computing platform may receive transaction data in real-time and construct a temporal graph data structure in which nodes represent accounts and edges represent transactions between accounts, with timestamps associated with the edges to preserve temporal information. The temporal graph may be maintained within a rolling time window, with edges older than a retention period being removed to bound the size of the graph data structure and focus computational resources on recent transaction activity.

In some cases, the computing platform may perform localized random walks on the temporal graph to generate node embeddings that encode structural relationships and connectivity patterns among accounts. Rather than recomputing embeddings for the entire graph when new transaction data arrives, the computing platform may perform incremental embedding updates by executing random walks starting from accounts involved in newly received transactions. This approach may reduce computational overhead and enable the embeddings to reflect current graph topology without requiring full recomputation of the graph structure.

The computing platform may fuse the node embeddings with behavioral feature data to generate feature vectors that combine structural information from the temporal graph with contextual information associated with the accounts. A machine learning model, such as a temporal graph transformer model, may process the fused feature vectors to generate suspicion scores indicating the likelihood of unauthorized activity associated with particular accounts or transactions.

In some aspects, the computing platform may aggregate suspicion scores across connected nodes within the temporal graph to evaluate clusters of accounts rather than individual transactions in isolation. This cluster-level analysis may enable detection of coordinated unauthorized activity patterns that span multiple accounts. The computing platform may compare aggregated scores to adaptive thresholds that adjust based on factors such as transaction volume and historical data, allowing the system to calibrate detection sensitivity to varying conditions.

When aggregated scores exceed the adaptive threshold, the computing platform may generate explainability data that provides information regarding why a particular cluster was flagged, including attention weights, importance scores, and transaction paths that contributed to the determination. The computing platform may also execute automated remediation actions, such as generating alerts, blocking accounts, or initiating investigations, based on the detection results. Case records, suspicion scores, and explainability data may be stored and made available for retrieval by analyst computing devices, enabling visualization of connected nodes and review of flagged activity.

In some examples, the computing platform may support privacy-preserving distributed learning by receiving model gradient updates from external systems and updating parameters of the machine learning model without requiring access to raw transaction data from those external systems. This approach may enable collaborative model training across multiple regions or entities while maintaining data privacy.

The technical improvements provided by the disclosed systems and methods may include reduced computational overhead through incremental embedding updates, improved detection accuracy through cluster-level analysis of connected accounts, and faster response times through real-time processing of transaction data. These improvements may enable detection and mitigation of coordinated unauthorized activity as it occurs, rather than through delayed batch analysis.

These and various other arrangements will be discussed more fully below.

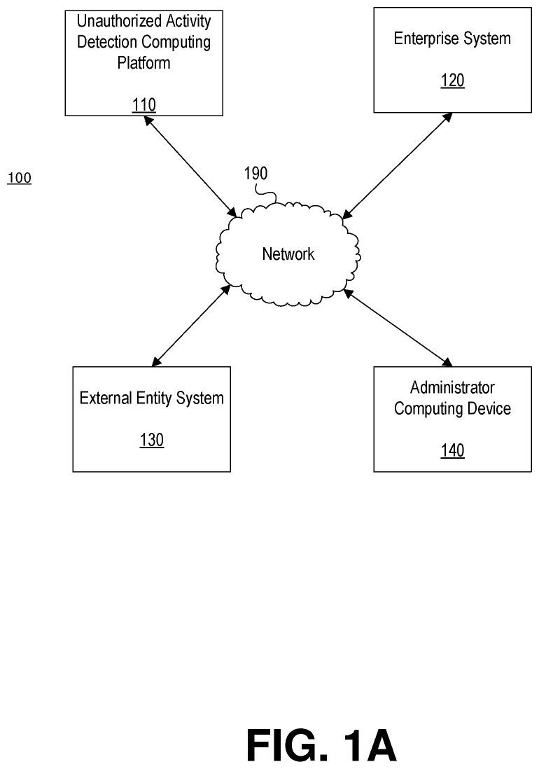

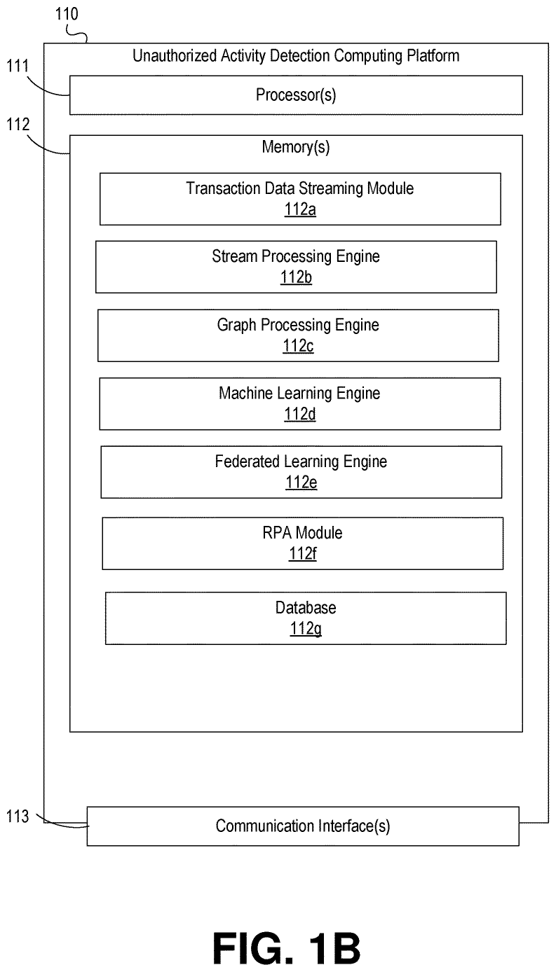

FIGS. 1A-1B depict an illustrative computing environment and devices for real-time detection and mitigation of coordinated unauthorized activity in transaction processing systems. Referring to FIG. 1A, computing environment 100 may include one or more computing devices and/or other computing systems. For example, computing environment 100 may include unauthorized activity detection computing platform 110, enterprise system 120, external entity system 130, and/or administrator computing device 140.

Although one enterprise system 120, external entity system 130 and administrator computing device 140 are shown, any number of systems or devices may be used without departing from the invention.

The unauthorized activity detection computing platform 110 may may be or include one or more computing devices or components (e.g., servers, server blades, desktop computers, laptop computers, processors, memory, and the like) and may be configured to receive and process transaction data to identify potentially fraudulent activity patterns, such as fraud rings, in real time. For instance, the unauthorized activity detection computing platform 110 may construct and maintain temporal graph data structures representing relationships between accounts and transactions, generate node embeddings through localized random walks, and apply machine learning models to detect coordinated unauthorized activity across multiple accounts. The unauthorized activity detection computing platform 110 may also generate suspicion scores, aggregate scores across connected account clusters, and execute automated remediation actions based on detection results.

In some arrangements, the unauthorized activity detection computing platform 110 may receive and process incoming transaction data in real-time, enabling continuous monitoring of transaction activity as it occurs. The unauthorized activity detection computing platform 110 may also process the streamed transaction data, preparing it for further analysis and temporal graph construction.

In some examples, the unauthorized activity detection computing platform 110 may construct and maintain temporal graphs representing relationships between accounts and transactions. The unauthorized activity detection computing platform 110 may perform operations such as localized random walks and node embedding generation to capture structural relationships and connectivity patterns among accounts. The unauthorized activity detection computing platform 110 may apply or execute machine learning models, including temporal graph transformer models, to analyze patterns within the temporal graph and generate suspicion scores for accounts and transaction clusters.

The unauthorized activity detection computing platform 110 may be configured to support privacy-preserving distributed learning. For instance, the unauthorized activity detection computing platform 110 may enable collaborative model training across multiple regions or entities by receiving and processing model gradient updates without requiring access to raw transaction data from external systems. The unauthorized activity detection computing platform 110 may also include a robotic process automation (RPA) module configured to execute automated remediation actions based on detection results. The RPA module may perform actions such as blocking accounts, generating alerts, or initiating investigation workflows when suspicious activity clusters are identified. The unauthorized activity detection computing platform 110 may further store transaction attributes, temporal graphs, node embeddings, suspicion scores, explainability data, and case records for retrieval and analysis by authorized users and systems.

The enterprise system 120 may be or include one or more computing devices or components (e.g., servers, server blades, desktop computers, laptop computers, mobile devices, processors, memory, and the like) and may provide transaction data and account information to the unauthorized activity detection computing platform 110 for analysis. In some examples, the enterprise system 120 may be a financial institution system, a payment processing system, or another system that generates or processes monetary transactions and associated with the enterprise implementing the unauthorized activity detection computing platform 110. The enterprise system 120 may receive remediation signals from the unauthorized activity detection computing platform 110 to execute actions such as blocking accounts or restricting transaction capabilities when suspicious activity is detected.

The external entity system 130 may be or include one or more computing devices or components (e.g., servers, server blades, desktop computers, laptop computers, mobile devices, processors, memory, and the like) and may represent systems outside the enterprise organization that interact with the unauthorized activity detection computing platform 110. In some examples, the external entity system 130 may be an external financial institution, a data provider, or a partner organization other than the enterprise implementing the unauthorized activity detection computing platform 110. The external entity system 130 may provide additional transaction data to the unauthorized activity detection computing platform 110 and may participate in privacy-preserving distributed learning by sharing model gradient updates without sharing raw transaction data.

The administrator computing device 140 may may be or include one or more computing devices or components (e.g., desktop computers, laptop computers, mobile devices, processors, memory, and the like) and may enable administrators or analysts to interact with the unauthorized activity detection computing platform 110. Through the administrator computing device 140, users may review alerts, examine case records, visualize connected nodes within temporal graphs, and manage remediation actions. The administrator computing device 140 may receive notifications from the unauthorized activity detection computing platform 110 when suspicious activity clusters are detected and may retrieve suspicion scores and explainability data for review.

Computing environment 100 also may include one or more networks, which may interconnect and/or serve as a communication medium enabling data exchange between one or more of unauthorized activity detection computing platform 110, enterprise system 120, external entity system 130, and/or administrator computing device 140. The network 190 may enable the exchange of transaction data, alerts, notifications, model gradient updates, and other information for the detection and mitigation of unauthorized transaction activity. For example, computing environment 100 may include network 190, which may include one or more wired networks, wireless networks, or combinations thereof. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may include the internet, a cellular network or another communication network. Network 190 may interconnect one or more computing devices associated with the organization and/or external to the organization. For example, unauthorized activity detection computing platform 110, enterprise system 120, external entity system 130, and/or administrator computing device 140 may be connected via network 190.

Referring to FIG. 1B, unauthorized activity detection computing platform 110 may include one or more processors 111, a memory 112, and a communication interface 113. A data bus may interconnect processor 111, memory 112, and communication interface 113. Communication interface 113 may be a network interface configured to support communication between unauthorized activity detection computing platform 110 and one or more networks (e.g., network 190, or the like). Memory 112 may include one or more program modules having instructions that when executed by processor 111 cause unauthorized activity detection computing platform 110 to perform one or more functions described herein and/or one or more databases that may store and/or otherwise maintain information which may be used by such program modules and/or processor 111. In some instances, the one or more program modules and/or databases may be stored by and/or maintained in different memory units of unauthorized activity detection computing platform 110 and/or by different computing devices that may form and/or otherwise make up unauthorized activity detection computing platform 110.

For instance, memory 112 may store computer-readable instructions that, when executed by the processor 111, cause the unauthorized activity detection computing platform 110 to perform various operations, including implementing unauthorized activity detection functionality. For example, memory 112 may have, store and/or include transaction data streaming module 112a, stream processing engine 112b, graph processing engine 112c, machine learning engine 112d, federated learning engine 112e, robotic process automation (RPA) module 112f and/or database 112g.

For instance, memory 112 may include transaction data streaming module 112a that may store instructions and/or data that may cause or enable the unauthorized activity detection computing platform 110 to receive and process incoming transaction data in real-time. The transaction data streaming module 112a may use one or more stream processing platforms to facilitate scalable, high-throughput data streaming with low latency for real-time data collection. The transaction data streaming module 112a may enable continuous monitoring of transaction activity as transactions occur, providing a live data stream that forms a foundation for temporal graph construction and analysis.

In some examples, the memory 112 may include a stream processing engine 112b that may store instructions and/or data that may cause or enable the unauthorized activity detection computing platform 110 to process streamed transaction data. The stream processing engine 112b may use one or more distributed processing engines to process data in micro-batches or streams to prepare for graph updates. The stream processing engine 112b may prepare transaction data for further analysis and temporal graph construction by the graph processing engine 112c.

The memory 112 may include a graph processing engine 112c that may store instructions and/or data that may cause or enable the unauthorized activity detection computing platform 110 to construct and maintain temporal graphs representing relationships between accounts and transactions. The graph processing engine 112c may use one or more distributed graph databased for scalable, real-time graph storage and updates. In some aspects, the graph processing engine 112c may use one or more application programming interfaces (APIs) for graph processing to enable dynamic graph processing on streaming data for continuous updates. The graph processing engine 112c may perform operations such as localized random walks and node embedding generation to capture structural relationships and connectivity patterns among accounts involved in recent transactions.

The memory 112 may include a machine learning engine 112d the may store instructions and/or data that may cause or enable the unauthorized activity detection computing platform 110 to apply or execute machine learning models to analyze patterns within the temporal graph and generate suspicion scores for accounts and transaction clusters. The machine learning engine 112d may use various algorithms for incremental embedding updates, enabling the machine learning engine 112d to update node embeddings without requiring full recomputation of the entire graph structure. In some aspects, the machine learning engine 112d may use one or more learning frameworks for training and deployment of transformer-based models.

The machine learning engine 112d may implement a temporal graph transformer model that uses Graph Attention Networks (GATs) or Temporal Graph Attention Network (TGAT) implementations to capture temporal dependencies and structural importance dynamically. In some cases, the temporal graph transformer model may use DyRep or Temporal Graph Network (TGN) approaches for temporal modeling of transaction patterns. The temporal graph transformer model may include attention mechanisms configured to weight temporal dependencies between nodes based on transaction timing patterns. The machine learning engine 112d may use one or more platforms or frameworks for data transformation when generating fused feature vectors that combine node embeddings with behavioral feature data.

In some examples, the machine learning engine 112d may apply adaptive thresholds when comparing aggregated suspicion scores. The adaptive thresholds may be dynamically adjusted using statistical libraries based on factors such as transaction volume, account types, and historical data. The machine learning engine 112d may generate explainability data using Shapley Additive exPlanations (SHAP) or Local Interpretable Model-agnostic Explanations (LIME) model interpretability tools. In some cases, the explainability data may include attention maps and temporal importance visualizations extracted from transformer-specific explainability techniques, providing transparency into the decision process of the temporal graph transformer model.

The memory 112 may include a federated learning engine 112e that may store instructions and/or data that may cause or enable the unauthorized activity detection computing platform 110 to support privacy-preserving distributed learning. The federated learning engine 112e may use various frameworks to facilitate privacy-preserving collaborative learning across multiple jurisdictions. In some aspects, the federated learning engine 112e may implement split learning as an alternative to federated learning for privacy-preserving distributed model training. The federated learning engine 112e may enable collaborative model training across multiple regions or entities by receiving and processing model gradient updates without requiring access to raw transaction data from external systems.

In some examples, the memory 112 may include a robotic process automation (RPA) module 112f configured to execute automated remediation actions based on detection results. The RPA module 112f that may store instructions and/or data that may cause or enable the unauthorized activity detection computing platform 110 to use robotic process automation tools for executing automated remediation actions such as temporarily blocking accounts, generating alerts, or initiating investigation workflows when suspicious activity clusters are identified.

The memory 112 may include a database 112g configured to store transaction attributes, temporal graphs, node embeddings, suspicion scores, explainability data, and case records for retrieval and analysis by authorized users and systems. The database 112g may support storage and retrieval operations for the transaction data streaming module 112a, the graph processing engine 112c, the machine learning engine 112d, and the RPA module 112f.

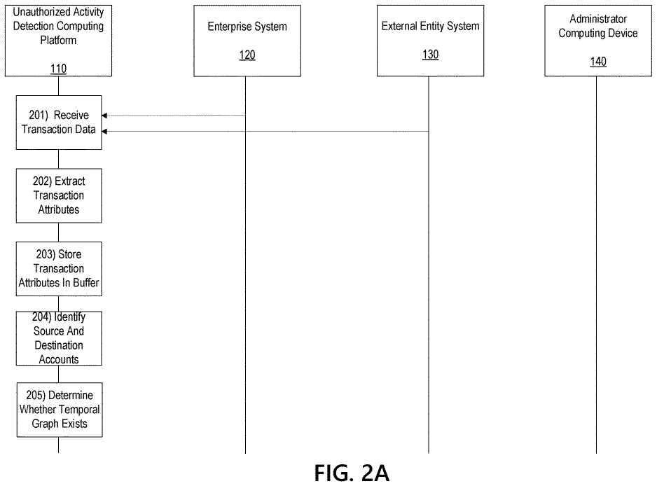

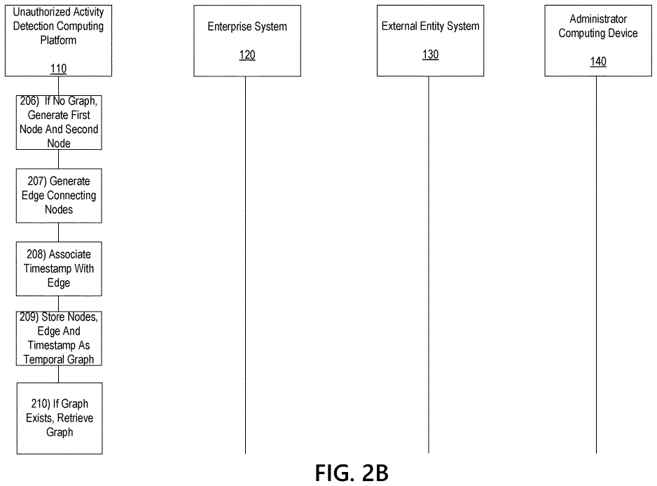

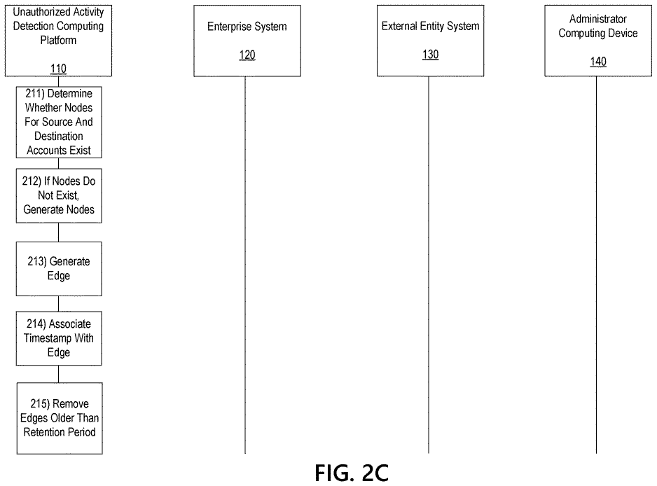

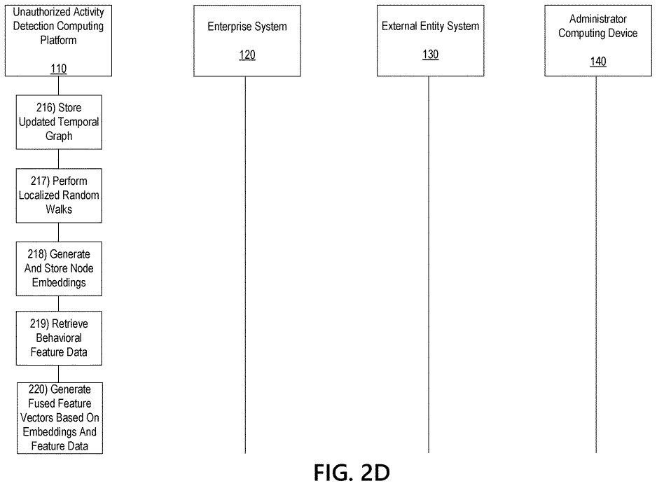

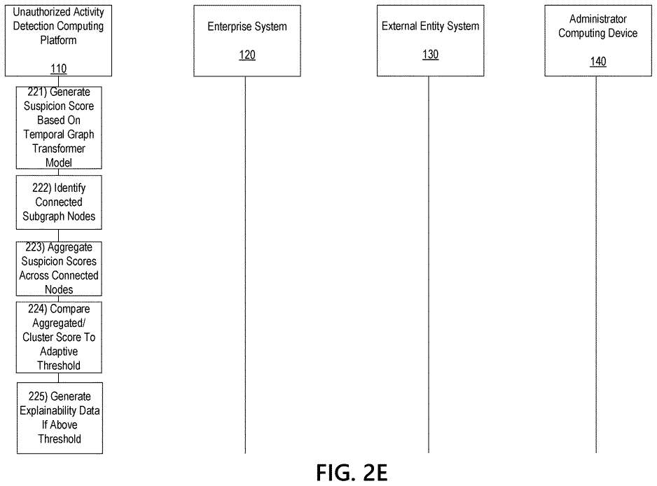

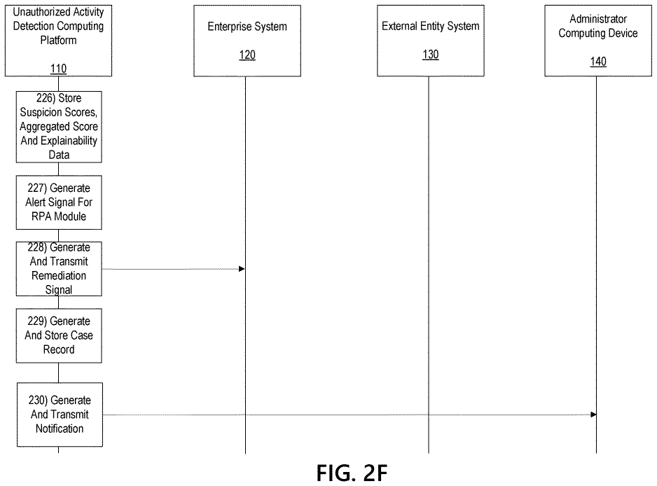

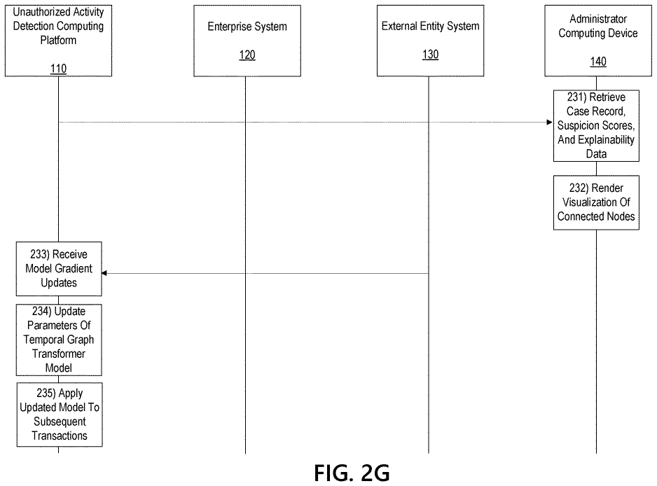

FIGS. 2A-2G illustrate an event sequence depicting a method for detecting and mitigating unauthorized activity in transaction data in accordance with one or more aspects described herein. The events shown in the illustrative event sequence are merely one example sequence and additional events may be added, or events may be omitted, without departing from the invention. Further, one or more processes discussed with respect to FIGS. 2A-2G may be performed in real-time or near real-time.

Referring to FIG. 2A, at step 201, unauthorized activity detection computing platform 110 may receive transaction data from one or more of the enterprise system 120 and the external entity system 130. The transaction data may include transaction amounts, timestamps, account identifiers, device information, account-to-account transfers, real-time payment (RTP) transactions, Automated Clearing House (ACH) credits and debits, wire requests, login and device signals, location and channel metadata, and account profile changes. The unauthorized activity detection computing platform 110 may stream these events through an ingestion pipeline and maintain recent events in fast processing systems to enable real-time analysis.

At step 202, unauthorized activity detection computing platform 110 may extract transaction attributes from the received transaction data. The transaction attributes may include details regarding the parties involved in the transaction, the transaction amount, the time of the transaction, and other contextual information.

At step 203, unauthorized activity detection computing platform 110 may store the transaction attributes in a buffer or temporary storage for subsequent processing. The stored transaction attributes may be maintained in fast processing systems to enable real-time analysis.

At step 204, unauthorized activity detection computing platform 110 may identify source and destination account identifiers from the transaction attributes. The source account identifier may correspond to an account from which funds are transferred, and the destination account identifier may correspond to an account to which funds are transferred. For example, in a fraud ring pattern, Account A may send funds to Accounts B, C, and D, which may then forward funds to external beneficiaries E and F. Such patterns may involve small incoming transfers, rapid layering across multiple mule accounts, and quick outbound payments to external accounts.

At step 205, unauthorized activity detection computing platform 110 may determine whether a temporal graph exists. For instance, unauthorized activity detection computing platform 110 may check whether a temporal graph data structure has been previously established for the transaction network. If a temporal graph structure exists, the process may continue at step 210 in FIG. 2B, otherwise the process may proceed to step 206 in FIG. 2B.

Referring to FIG. 2B, at step 206, if no temporal graph exists, the unauthorized activity detection computing platform 110 may generate a first node and a second node. The first node may correspond to the source account identifier, and the second node may correspond to the destination account identifier. The nodes may represent accounts within the temporal graph data structure.

At step 207, the unauthorized activity detection computing platform 110 may generate an edge connecting the first node and the second node. The edge may represent a transaction relationship between the accounts corresponding to the first node and the second node. In the temporal graph, nodes may represent accounts and edges may represent transactions between accounts. For example, the graph may include edges such as A→B, A→C, A→D, B→E, C→E, and D→F, where Account A distributes funds to Accounts B, C, and D, which then forward funds to shared external beneficiaries E and F.

At step 208, the unauthorized activity detection computing platform 110 may associate timestamp with edge. The timestamp may indicate when the transaction occurred, enabling temporal analysis of transaction patterns within the temporal graph. The temporal graph may make it easier to detect unusual clusters, rapid fan-out patterns, repeated reuse of the same beneficiary, and tightly connected groups acting in coordination.

At step 209, the unauthorized activity detection computing platform 110 may store nodes, edge and timestamp in the temporal graph. The temporal graph may be stored in the database 112g for subsequent retrieval and analysis.

At step 210, if a temporal graph exists or based on creating the temporal graph, the unauthorized activity detection computing platform 110 may retrieve the temporal graph from the database 112g. The retrieved temporal graph may contain nodes and edges representing previously processed transactions.

Referring to FIG. 2C, at step 211, the unauthorized activity detection computing platform 110 may determine whether nodes for the source and destination account identifiers exist in the temporal graph. The determination may check whether the accounts involved in the current transaction are already represented as nodes in the temporal graph structure.

At step 212, if nodes for the account identifiers do not exist, the unauthorized activity detection computing platform 110 may generate first and second nodes corresponding to the source and destination account identifiers. The generated nodes may be added to the temporal graph to represent the newly encountered accounts.

At step 213, the unauthorized activity detection computing platform 110 may generate an edge between first and second node. The edge may represent the transaction relationship between the source account and the destination account.

At step 214, the unauthorized activity detection computing platform 110 may associate the edge with a timestamp. The timestamp may preserve temporal information regarding when the transaction occurred.

At step 215, after generating the first and second node or if the first and second nodes exist, the unauthorized activity detection computing platform 110 may remove edges older than a retention period. The retention period may, in some examples, be approximately 24 hours, which may bound the size of the temporal graph and focus computational resources on recent transaction activity. The temporal graph may maintain a rolling retention window for edge expiration to bound graph size and processing time.

Referring to FIG. 2D, at step 216, the unauthorized activity detection computing platform 110 may store the updated temporal graph in the database 112g. The updated temporal graph may reflect the newly added nodes and edges as well as the removal of expired edges.

At step 217, the unauthorized activity detection computing platform 110 may perform localized random walks on the temporal graph. The localized random walks may be short random walks (e.g., having a defined walk length) starting from accounts involved in newly arriving transactions rather than full graph traversals. When a new transaction arrives, the unauthorized activity detection computing platform 110 might not rebuild the entire network understanding but instead may start a few short walks from the accounts involved in that new transaction and update only the account representations affected by that new connection. The unauthorized activity detection computing platform 110 may reuse the existing graph structure, the previously computed node embeddings, and the prior neighborhood topology already stored in the graph processing engine 112c.

At step 218, the unauthorized activity detection computing platform 110 may generate and store node embeddings based on the localized random walks. The node embeddings may be low-dimensional numerical representations that encode both structural and temporal information about account relationships. The node embeddings may represent how an account is connected, how recently the account acted, who the account transacts with, and what role the account plays in the graph. For example, before suspicious activity, Account A may appear low-risk and isolated, but after rapid transactions, Account A may appear as the center of a fast-moving cluster, Accounts B, C, and D may appear as relay or mule accounts, and Accounts E and F may appear as common exit destinations. In some aspects, the unauthorized activity detection computing platform 110 may separate embedding updates from temporal scoring by first refreshing embeddings via streaming random walks and then applying transformer-based temporal fraud scoring.

At step 219, the unauthorized activity detection computing platform 110 may retrieve behavioral feature data associated with the accounts represented in the temporal graph. The behavioral feature data may include transaction frequency, typical amounts, risk flags, device consistency, login channel behavior, beneficiary reuse, account age, previous alerts, velocity, and time gaps. The behavioral feature data may provide contextual information regarding account activity patterns.

At step 220, the unauthorized activity detection computing platform 110 may generate fused feature vectors based on embeddings and feature data. The fused feature vectors may combine the structural information captured in the node embeddings with the behavioral feature data to create comprehensive feature representations for each account or group of accounts. The fused feature vectors may be normalized and prepared in formats suitable for machine learning models, such as JSON or tensors.

Referring to FIG. 2E, at step 221, the unauthorized activity detection computing platform 110 may generate a suspicion score based on temporal graph transformer model. The suspicion score may be a real-time probability score between 0 and 1 indicating likelihood of fraud involvement. For example, the temporal graph transformer model may generate risk scores such as Account A risk score=0.94, Account B risk score=0.87, Account C risk score=0.85, and Account D risk score=0.83. The temporal graph transformer model may recognize a pattern as suspicious because funds were split quickly, several connected accounts acted in coordination, the network formed a dense suspicious cluster, and the behavior evolved within a short time window.

At step 222, the unauthorized activity detection computing platform 110 may identify connected subgraph nodes within the temporal graph. The connected subgraph may be identified as a dense cluster of accounts exhibiting coordinated transaction behavior within a short time window. For example, a cluster such as {A, B, C, D, E, F} may be flagged because multiple accounts in the same group are high-risk, the cluster is densely connected, and funds move rapidly through the cluster. The unauthorized activity detection computing platform 110 may assign a cluster identifier such as XX-XXXX-XXXXX with a cluster risk score of 0.92 and a priority level of High, with flagging reasons including rapid fan-out, relay pattern, shared endpoints, and timing concentration.

At step 223, the unauthorized activity detection computing platform 110 may aggregate suspicion scores across connected nodes. Rather than evaluating individual transactions or accounts in isolation, the aggregation may combine the suspicion scores of nodes within a connected subgraph to produce an aggregated score that reflects the collective risk level of the cluster. Investigators may no longer see multiple unrelated alerts but instead may see one probable fraud ring with all linked parties grouped together.

At step 224, the unauthorized activity detection computing platform 110 may compare the aggregated score to an adaptive threshold. The adaptive threshold may adjust based on transaction volume, account types, and historical data patterns. For instance, the adaptive threshold may be dynamically adjusted based on one or more of: aggregated suspicion scores from the temporal graph transformer model, cluster density of connected nodes, or temporal evolution of neighborhood structure within the temporal transaction graph. The adaptive threshold may allow the unauthorized activity detection computing platform 110 to dynamically calibrate detection sensitivity to varying conditions. In some aspects, the unauthorized activity detection computing platform 110 may distinguish legitimate dense transaction hubs from malicious fraud rings through combined streaming structural embeddings, temporal transformer scoring, and adaptive cluster-level thresholding.

In some cases, a fraud ring lifecycle may be defined such that a fraud ring is created when a connected group of accounts becomes suspicious together, persists while accounts remain connected and score above the adaptive threshold, and dissolves when edges age out of the retention period or scores fall below the adaptive threshold.

At step 225, the unauthorized activity detection computing platform 110 may generate explainability data if the aggregated score exceeds the adaptive threshold. The explainability data may include stored attention weights, importance scores, transaction paths, and model suspicion scores to enable real-time explainability without reconstructing historical data. For example, the explainability data may indicate that Account A sent funds to 3 related accounts within 4 minutes, that Accounts B, C, and D then routed funds to shared beneficiaries, and that device and login patterns are unusually similar across the cluster. The explainability data may provide information regarding why a particular cluster was flagged as suspicious, supporting audit compliance and enabling analysts to understand and verify the basis for the determination.

Referring to FIG. 2F, at step 226, the unauthorized activity detection computing platform 110 may store suspicion scores, aggregated score and explainability data in the database 112g. The stored data may be available for retrieval by authorized users and systems for review and analysis.

At step 227, the unauthorized activity detection computing platform 110 may generate an alert signal for RPA module 112f. The alert signal may trigger the RPA module 112f to execute automated remediation actions based on the detection results. In some examples, unauthorized activity detection computing platform 110 may generate a human-readable explanation of the alert signal based on the stored explainability data.

At step 228, the unauthorized activity detection computing platform 110 may generate and transmit a remediation signal to the enterprise system 120. The remediation signal may trigger API integrations with banking and anti-money laundering (AML) systems for swift response to detected fraud. In some aspects, the remediation signal may trigger temporary holds on outbound payments, enhanced monitoring of linked accounts, or dynamic increases in risk scores associated with flagged accounts. For example, the unauthorized activity detection computing platform 110 may block a pending transfer from Account D to Account F before settlement, place Accounts A, B, C, and D under enhanced monitoring, and trigger a fraud case with graph evidence attached. In some examples, the automated remediation action may include one or more of: transmitting a signal to block a pending transaction, increasing a risk score associated with one or more accounts in the connected subgraph, or generating an investigation case record.

At step 229, the unauthorized activity detection computing platform 110 may generate and store a case record in the database 112g. The case record may include transaction paths, suspicion scores, cluster identifiers, priority levels, and reasons for the alert. The case record may provide a comprehensive record of the detected suspicious activity for subsequent review and investigation.

At step 230, the unauthorized activity detection computing platform 110 may generate and transmit a notification to the administrator computing device 140. The notification may include alerts to fraud operations teams, case creation for investigation, and alerts to AML and compliance teams if escalation thresholds are crossed. In some cases, the full end-to-end detection may occur within minutes of the initial transaction. For example, an account may receive funds at 9:01 AM, distribute funds to multiple accounts at 9:03 AM, and have the automated response block the next outbound movement and start investigation by 9:08 AM. In some cases, the unauthorized activity detection computing platform 110 may continuously monitor flagged accounts for repeated suspicious activity and dynamically adjust risk levels associated with the flagged accounts based on ongoing activity.

Referring to FIG. 2G, at step 231, the administrator computing device 140 may retrieve the case record, suspicion scores and explainability data from the unauthorized activity detection computing platform 110. The retrieved data may enable an analyst or administrator to review the detected suspicious activity and the basis for the determination.

At step 232, the administrator computing device 140 may render visualization of connected nodes within the temporal graph. The visualization of connected nodes may be rendered using web frameworks with visualization libraries. The visualization may allow an analyst or administrator to view the relationships between accounts involved in potentially suspicious transaction patterns.

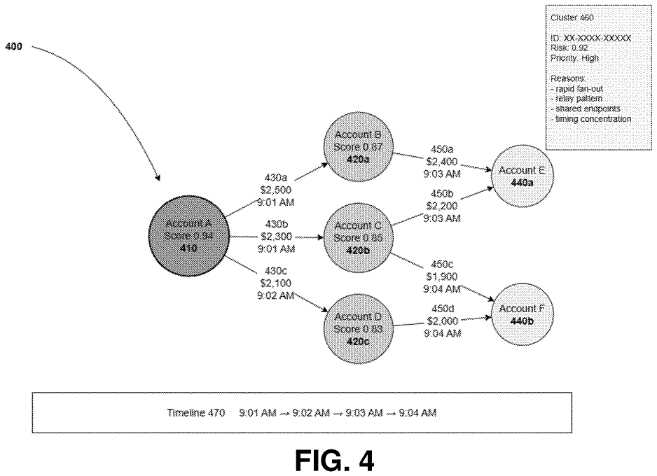

FIG. 4 illustrates one example visualization 400 of a fraud ring cluster as rendered by the administrator computing device 140. The visualization 400 may display a temporal graph representation of connected accounts and transactions identified as part of a suspicious activity cluster. The visualization 400 may include a central node 410 representing Account A, which may be visually distinguished by a larger size or distinct color to indicate its role as a hub account with a high suspicion score of 0.94. The visualization 400 may further include intermediate nodes 420a, 420b, and 420c representing Accounts B, C, and D respectively, which may be positioned around the central node 410 and connected to it by directed edges 430a, 430b, and 430c. The intermediate nodes 420a, 420b, and 420c may be color-coded or shaded to reflect their respective suspicion scores of 0.87, 0.85, and 0.83. The visualization 400 may also include destination nodes 440 a and 440b representing Accounts E and F, which may be positioned at the periphery of the cluster and connected to the intermediate nodes 420a, 420b, and 420c by directed edges 450a, 450b, 450c, and 450d. The edges 430a, 430b, 430c, 450a, 450b, 450c, and 450d may be annotated with transaction amounts and timestamps to provide temporal context. For example, edge 430a may display “$2,500 @ 9:01 AM” to indicate a transfer of $2,500 from Account A to Account B at 9:01 AM. The visualization 400 may include a cluster information panel 460 displaying metadata such as cluster identifier XX-XXXX-XXXXX, cluster risk score of 0.92, priority level of High, and flagging reasons including rapid fan-out, relay pattern, shared endpoints, and timing concentration. The visualization 400 may further include a timeline component 470 showing the temporal evolution of the cluster, with markers indicating when each transaction occurred and how the cluster formed over time. The visualization 400 may enable an analyst to interactively explore the cluster by selecting nodes to view detailed account information, hovering over edges to see transaction details, and adjusting time ranges to observe how the cluster evolved. The visualization 400 may use color gradients, node sizing, and edge thickness to convey risk levels, transaction volumes, and connection strengths, providing an intuitive representation of the fraud ring structure that facilitates rapid assessment and investigation by fraud analysts.

With further reference to FIG. 2G, at step 233, the unauthorized activity detection computing platform 110 may receive model gradient updates from the external entity system 130. The model gradient updates may be received as part of privacy-preserving distributed learning, where model updates rather than raw transaction data are shared between systems. For example, where a fraud ring spans multiple regions or subsidiaries and privacy rules prevent raw data sharing, one entity may see Accounts A, B, and C while another entity may see Accounts E and F, and the unauthorized activity detection computing platform 110 may use federated or split learning to share model updates instead of raw customer data, thereby improving ring detection across geographies without violating privacy boundaries.

At step 234, the unauthorized activity detection computing platform 110 may update parameters of the temporal graph transformer model based on the received model gradient updates. The parameter updates may refine the temporal graph transformer model to improve detection of suspicious patterns based on new information. In some aspects, the unauthorized activity detection computing platform 110 may process transactions involving accounts across multiple regions or subsidiaries while maintaining data privacy through federated or split learning that shares model updates rather than raw customer data.

At step 235, the unauthorized activity detection computing platform 110 may apply the updated model to subsequent transactions. The application of the updated temporal graph transformer model may enable the unauthorized activity detection computing platform 110 to adapt and improve detection capabilities over time based on accumulated learning from multiple sources.

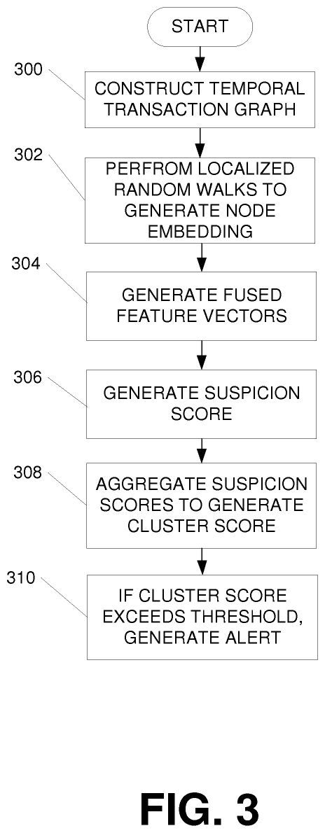

FIG. 3 is a flow chart illustrating one example method for detecting unauthorized activity in transaction data in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

The method may begin at a step 300, where the unauthorized activity detection computing platform 110 may construct temporal transaction graph. For instance, unauthorized activity detection computing platform 110 may construct a temporal transaction graph in which account identifiers are represented as nodes and transactions between accounts are represented as edges, with each edge having an associated timestamp. The temporal transaction graph may be maintained within a rolling time window by removing edges having timestamps older than a defined retention period, which may be approximately 24 hours, to bound graph size and focus computational resources on recent transaction activity.

At step 302, unauthorized activity detection computing platform 110 may perform localized random walks to generate node embeddings. For instance, responsive to receipt of a new transaction via the communication interface, the unauthorized activity detection computing platform 110 may perform a localized random walk from one or more nodes corresponding to accounts involved in the new transaction to generate an updated node embedding for each involved node without recomputing embeddings for nodes not affected by the new transaction. The localized random walk may comprise performing a plurality of short random walks of a defined walk length starting from the one or more nodes corresponding to the accounts involved in the new transaction. In some examples, unauthorized activity detection computing platform 110 may reuse the existing graph structure and previously computed embeddings, updating only the account representations affected by the new connection. The node embeddings may be low-dimensional numerical representations that encode both structural and temporal information about account relationships.

At step 304, unauthorized activity detection computing platform 110 may generate fused feature vectors. For instance, unauthorized activity detection computing platform 110 may fuse the updated node embeddings with behavioral feature data associated with the involved accounts to generate fused feature vectors. The behavioral feature data may comprise one or more of: transaction frequency, transaction amount statistics, device identifiers, login channel indicators, beneficiary reuse counts, account age, or velocity metrics. The fused feature vectors may be normalized and prepared in formats suitable for machine learning models, such as JSON or tensors, creating comprehensive feature representations for each account or group of accounts that combine structural data from the temporal graph with behavioral signals.

At step 306, unauthorized activity detection computing platform 110 may generate a suspicion score. For instance, unauthorized activity detection computing platform 110 may apply a temporal graph transformer model to the fused feature vectors to generate a suspicion score for each involved node. The temporal graph transformer model may comprise attention mechanisms configured to weight temporal dependencies between nodes based on transaction timing patterns. The suspicion score may be a real-time probability score between 0 and 1 indicating the likelihood of fraud involvement. In some aspects, unauthorized activity detection computing platform 110 may store, for each node for which a suspicion score is generated, explainability data comprising attention weights and feature importance values derived from the temporal graph transformer model. In some cases, the computing platform may generate a human-readable explanation based on the stored explainability data.

At step 308, unauthorized activity detection computing platform 110 may aggregate suspicion scores to generate a cluster score. For instance, unauthorized activity detection computing platform 110 may aggregate the suspicion scores across a connected subgraph of nodes to generate a cluster score that reflects the collective risk level of groups of accounts that may be operating together. Rather than evaluating individual transactions or accounts in isolation, the cluster-level analysis may enable detection of coordinated unauthorized activity patterns that span multiple accounts. The adaptive threshold may be dynamically adjusted based on one or more of: aggregated suspicion scores from the temporal graph transformer model, cluster density of connected nodes, or temporal evolution of neighborhood structure within the temporal transaction graph.

At step 310, unauthorized activity detection computing platform 110 may, if the cluster score exceeds an adaptive threshold, generate an alert. For instance, responsive to the cluster score exceeding an adaptive threshold, unauthorized activity detection computing platform 110 may transmit an alert signal via the communication interface. In some aspects, responsive to the cluster score exceeding the adaptive threshold, the computing platform may initiate an automated remediation action comprising one or more of: transmitting a signal to block a pending transaction, increasing a risk score associated with one or more accounts in the connected subgraph, or generating an investigation case record. In some cases, the computing platform may perform privacy-preserving distributed learning by receiving model gradient updates from one or more remote computing systems and updating the temporal graph transformer model based on the received model gradient updates without receiving raw transaction data from the remote computing systems.

The arrangements described herein may provide real-time detection and mitigation of coordinated unauthorized activity in transaction processing systems through a combination of temporal graph construction, localized random walk embedding updates, fused feature vectors, temporal graph transformer model scoring, cluster-level aggregation with adaptive thresholds, explainability, automated remediation, and privacy-preserving distributed learning. The temporal graph may represent accounts as nodes and transactions as edges with associated timestamps, maintained within a rolling time window to focus computational resources on recent activity. When new transactions arrive, the computing platform may perform localized random walks starting from involved accounts to generate updated node embeddings without requiring full graph recomputation. The node embeddings may be fused with behavioral feature data to create comprehensive feature vectors that combine structural information from the temporal graph with contextual information associated with the accounts. A temporal graph transformer model may process the fused feature vectors to generate suspicion scores, which may be aggregated across connected nodes to evaluate clusters of accounts rather than individual transactions in isolation. When aggregated scores exceed adaptive thresholds, the computing platform may generate explainability data and execute automated remediation actions such as blocking accounts or initiating investigations.

As discussed herein, the arrangements may reduce computational overhead through incremental embedding updates rather than full graph recomputation, improve detection of coordinated activity through cluster-level analysis rather than isolated transaction evaluation, improve response times through real-time processing that enables detection and mitigation as unauthorized activity occurs, distinguish legitimate dense transaction hubs from fraud rings through combined streaming structural embeddings and temporal transformer scoring with adaptive cluster-level thresholding, and enable cross-region collaborative learning without sharing raw transaction data through privacy-preserving distributed learning approaches. These improvements may enable financial institutions and other organizations to detect and respond to coordinated unauthorized activity patterns such as fraud rings as they form and evolve, rather than through delayed batch analysis that may occur after funds have already been transferred to their intended destinations.

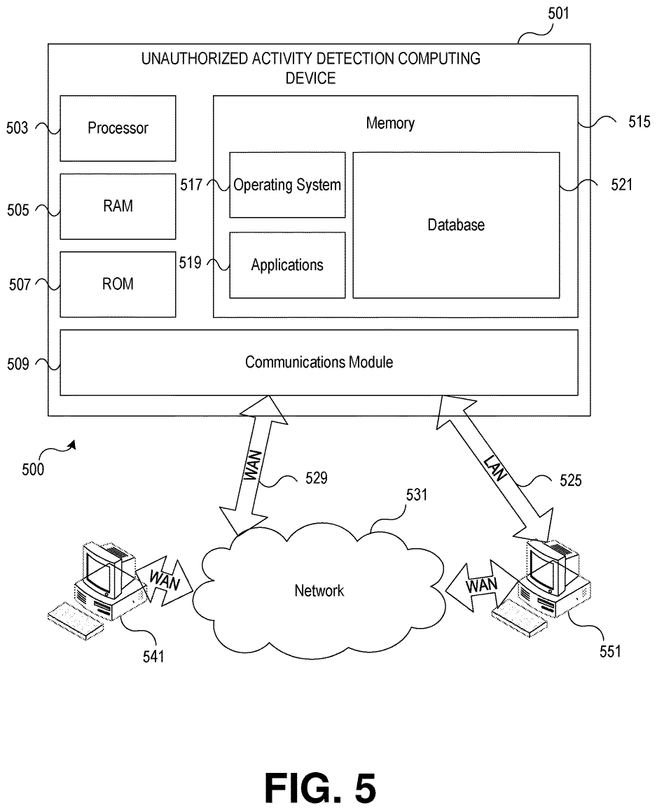

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 500.

Computing system environment 500 may include unauthorized activity detection computing device 501 having processor 503 for controlling overall operation of unauthorized activity detection computing device 501 and its associated components, including Random Access Memory (RAM) 505, Read-Only Memory (ROM) 507, communications module 509, and memory 515. Unauthorized activity detection computing device 501 may include a variety of computer readable media. Computer readable media may be any available media that may be accessed by unauthorized activity detection computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by unauthorized activity detection computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on unauthorized activity detection computing device 501. Such a processor may execute computer-executable instructions stored on a computer-readable medium.

Software may be stored within memory 515 and/or storage to provide instructions to processor 503 for enabling unauthorized activity detection computing device 501 to perform various functions as discussed herein. For example, memory 515 may store software used by unauthorized activity detection computing device 501, such as operating system 517, application programs 519, and associated database 521. Also, some or all of the computer executable instructions for unauthorized activity detection computing device 501 may be embodied in hardware or firmware. Although not shown, RAM 505 may include one or more applications representing the application data stored in RAM 505 while unauthorized activity detection computing device 501 is on and corresponding software applications (e.g., software tasks) are running on unauthorized activity detection computing device 501.

Communications module 509 may include a microphone, keypad, touch screen, and/or stylus through which a user of unauthorized activity detection computing device 501 may provide input, and may also include one or more of a speaker for providing audio output and a video display device for providing textual, audiovisual and/or graphical output. Computing system environment 500 may also include optical scanners (not shown).

Unauthorized activity detection computing device 501 may operate in a networked environment supporting connections to one or more remote computing devices, such as computing devices 541 and 551. Computing devices 541 and 551 may be personal computing devices or servers that include any or all of the elements described above relative to unauthorized activity detection computing device 501.

The network connections depicted in FIG. 5 may include Local Area Network (LAN) 525 and Wide Area Network (WAN) 529, as well as other networks. When used in a LAN networking environment, unauthorized activity detection computing device 501 may be connected to LAN 525 through a network interface or adapter in communications module 509. When used in a WAN networking environment, unauthorized activity detection computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
construct a temporal transaction graph in which account identifiers are represented as nodes and transactions between accounts are represented as edges, each edge having an associated timestamp;
responsive to receipt of a new transaction via the communication interface, execute a localized random walk from one or more nodes corresponding to accounts involved in the new transaction to generate an updated node embedding for each involved node without recomputing embeddings for nodes not affected by the new transaction;
fuse the updated node embeddings with behavioral feature data associated with the involved accounts to generate fused feature vectors;
apply a temporal graph transformer model to the fused feature vectors to generate a suspicion score for each involved node;
aggregate the suspicion scores across a connected subgraph of nodes to generate a cluster score; and
responsive to the cluster score exceeding an adaptive threshold, transmit an alert signal via the communication interface.

2. The computing platform of claim 1, further including instructions that, when executed, cause the computing platform to:
maintain the temporal transaction graph within a rolling time window by removing edges having timestamps older than a defined retention period.

3. The computing platform of claim 1, wherein the localized random walk comprises performing a plurality of short random walks of a defined walk length starting from the one or more nodes corresponding to the accounts involved in the new transaction.

4. The computing platform of claim 1, wherein the behavioral feature data comprises one or more of: transaction frequency, transaction amount statistics, device identifiers, login channel indicators, beneficiary reuse counts, account age, or velocity metrics.

5. The computing platform of claim 1, wherein the temporal graph transformer model comprises attention mechanisms configured to weight temporal dependencies between nodes based on transaction timing patterns.

6. The computing platform of claim 1, further including instructions that, when executed, cause the computing platform to:
store, for each node for which a suspicion score is generated, explainability data comprising attention weights and feature importance values derived from the temporal graph transformer model.

7. The computing platform of claim 6, further including instructions that, when executed, cause the computing platform to:
generate a human-readable explanation of the alert signal based on the stored explainability data.

8. The computing platform of claim 1, wherein the adaptive threshold is dynamically adjusted based on one or more of: aggregated suspicion scores from the temporal graph transformer model, cluster density of connected nodes, or temporal evolution of neighborhood structure within the temporal transaction graph.

9. The computing platform of claim 1, further including instructions that, when executed, cause the computing platform to:
responsive to the cluster score exceeding the adaptive threshold, initiate an automated remediation action comprising one or more of: transmitting a signal to block a pending transaction, increasing a risk score associated with one or more accounts in the connected subgraph, or generating an investigation case record.

10. The computing platform of claim 1, further including instructions that, when executed, cause the computing platform to:
perform privacy-preserving distributed learning by receiving model gradient updates from one or more remote computing systems and updating the temporal graph transformer model based on the received model gradient updates without receiving raw transaction data from the remote computing systems.

11. A method, comprising:
constructing, by a computing platform having at least one processor, and memory, a temporal transaction graph in which account identifiers are represented as nodes and transactions between accounts are represented as edges, each edge having an associated timestamp;
responsive to receipt of a new transaction via a communication interface, executing, by the at least one processor, a localized random walk from one or more nodes corresponding to accounts involved in the new transaction to generate an updated node embedding for each involved node without recomputing embeddings for nodes not affected by the new transaction;
fusing, by the at least one processor, the updated node embeddings with behavioral feature data associated with the involved accounts to generate fused feature vectors;
applying, by the at least one processor, a temporal graph transformer model to the fused feature vectors to generate a suspicion score for each involved node;
aggregating, by the at least one processor, the suspicion scores across a connected subgraph of nodes to generate a cluster score; and
responsive to the cluster score exceeding an adaptive threshold, transmitting, by the at least one processor, an alert signal via the communication interface.

12. The method of claim 11, further including:
maintaining, by the at least one processor, the temporal transaction graph within a rolling time window by removing edges having timestamps older than a defined retention period.

13. The method of claim 11, wherein the localized random walk comprises performing a plurality of short random walks of a defined walk length starting from the one or more nodes corresponding to the accounts involved in the new transaction.

14. The method of claim 11, wherein the behavioral feature data comprises one or more of: transaction frequency, transaction amount statistics, device identifiers, login channel indicators, beneficiary reuse counts, account age, or velocity metrics.

15. The method of claim 11, wherein the temporal graph transformer model comprises attention mechanisms configured to weight temporal dependencies between nodes based on transaction timing patterns.

16. The method of claim 11, further including:
storing, for each node for which a suspicion score is generated, explainability data comprising attention weights and feature importance values derived from the temporal graph transformer model.

17. The method of claim 11, wherein the adaptive threshold is dynamically adjusted based on one or more of: aggregated suspicion scores from the temporal graph transformer model, cluster density of connected nodes, or temporal evolution of neighborhood structure within the temporal transaction graph.

18. The method of claim 11, further including:
responsive to the cluster score exceeding the adaptive threshold, initiating an automated remediation action comprising one or more of: transmitting a signal to block a pending transaction, increasing a risk score associated with one or more accounts in the connected subgraph, or generating an investigation case record.

19. The method of claim 11, further including:
performing privacy-preserving distributed learning by receiving model gradient updates from one or more remote computing systems and updating the temporal graph transformer model based on the received model gradient updates without receiving raw transaction data from the remote computing systems.

20. One or more non-transitory computer-readable media storing instructions that, when executed by a computing platform comprising at least one processor, memory, and a communication interface, cause the computing platform to:
construct a temporal transaction graph in which account identifiers are represented as nodes and transactions between accounts are represented as edges, each edge having an associated timestamp;
responsive to receipt of a new transaction via the communication interface, execute a localized random walk from one or more nodes corresponding to accounts involved in the new transaction to generate an updated node embedding for each involved node without recomputing embeddings for nodes not affected by the new transaction;
fuse the updated node embeddings with behavioral feature data associated with the involved accounts to generate fused feature vectors;
apply a temporal graph transformer model to the fused feature vectors to generate a suspicion score for each involved node;
aggregate the suspicion scores across a connected subgraph of nodes to generate a cluster score; and
responsive to the cluster score exceeding an adaptive threshold, transmit an alert signal via the communication interface.
